(19) United States
(12) Patent Application Publication
(10) Pub. No.: US 2007/0069662 A1
(43) Pub. Date: Mar. 29, 2007

(54) Current-balancing circuit for lamps

(76) Inventors: Chun-Kong Chan, Hsi Chih City (TW); Jeng-Shong Wang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/237,930

(22) Filed: Sep. 29, 2005

(51) Int. Cl. H05B 41/24

(52) U.S. Cl. 315/282

(57) ABSTRACT

The current-balancing circuit for lamps of the present invention adopts a plurality of transformers having a primary winding and a secondary winding. One end of the secondary winding of the transformer is connected with a lamp and another end of the secondary winding of the transformer is connected with an AC power via the primary winding of a neighboring transformer. By the above linking method, the power provides and balances the working current for the lamps via the transformers, and improves upon the drawbacks, including the inductance on the coils of the prior art being different and it not being able to be applied to lamps with an odd quantity and only can be applied to the lamps with an even quantity.

### BACKGROUND OF THE INVENTION

1. Field of the Invention

The present invention relates to a current-balancing circuit for lamps. In particular, this invention utilizes a linking relationship between a plurality of transformers and a plurality of lamps for balancing the current between the lamps.

2. Description of the Related Art

Due to technological developments and consumer demand, the size of LCD panels has become larger and larger. However, LCD panels with a single lamp cannot satisfy the requirements of illumination. Therefore, two or more lamps are necessary for the LCD panel. In order or make the brightness of the LCD panel balance, the current flowing through each lamp has to be adjusted in time to make the currents of each lamp equal. However, cold cathode fluorescent lamps (CCFLs) have the characteristics of high instability and negative resistance, so it is very difficult to maintain the resistance of the CCFL. Therefore, the resistance of each lamp is changed and the current flowing through each lamp is different. Because the currents flowing between the lamps are unequal, it makes the brightness unbalanced. Furthermore, the aging rate of the lamps is also different due to the fact that a larger current damages the lamp quicker.

Please refer to FIG. 1, which shows a schematic diagram of a circuit using a differential ballaster to adjust the current of two lamps of the prior art. The circuit includes a transformer 12 having a first coil 121 and a second coil 122. One end of the first coil 121 is connected with an AC power 10 and another end is connected with a first lamp 141. Another end of the first lamp 141 is connected with a reference voltage G. One end of the second coil 122 is also connected with the AC power 10 and another end is connected with a second lamp 142. Another end of the second lamp 142 is connected with the reference voltage G. The AC power 10 utilizes the first coil 121 and the second coil 122 of the transformer 12 to form a differential ballaster for individually providing stable current I1 and I2 to the first lamp 141 and the second lamp 142. Therefore, the current flowing through the first lamp 141 and the second lamp 142 is balanced.

Please refer to FIGS. 1 and 2. FIG. 2 is a schematic diagram of an equivalent magnetic loop of the transformer 12 in the FIG. 1. As shown in FIG. 2, the magnetic core 120 includes two side columns A1 and A2, and two shoulder columns A3 and A4. When the currents I1 and I2 are the same, the current flowing through the first coil 121 and the second coil 122 is also equal. The magnetic force of the first coil 121 produced by the current I1 is the same as the magnetic force of the second coil 121 produced by the current I2. It means the magnetic force of the side column A1 is cancelled out by the magnetic force of the side column A2. Therefore, there is no magnetic flux between the shoulder column A3 and A4. At the same time, the magnetic flux φ1 and φ2 in the side column A1 and A2 individually forms a loop via the outside air gap. Because the magnetic resistance of the air gap is very high, the inductance induced by the loop is ignored.

Please refer to FIGS. 1 and 3. FIG. 3 shows a schematic diagram of an equivalent magnetic loop of FIG. 1 connected with lamps. When the current I1 of the first lamp 141 is different from the current I2 of the second lamp 142, the magnetic force of the first coil 121 produced by the current I1 is also different from the magnetic force of the second coil 121 produced by the current I2. This means that the magnetic force of the side column A1 is unequal to the magnetic force of the side column A2. The difference between the side column A1 and side column A2 produces a mass of magnetic flux φ on the low resistance loop composed by the side column A1, the side column A2, the shoulder column A3 and the shoulder column A4. The magnetic flux φ slices the first coil 121 and the second coil 122 and reacts and produces an amended voltage ΔV between the ends of the coils. The amended voltage ΔV forces the current I1 of the first lamp 141 and the current I2 of the second lamp 142 to recover and balance.

Please refer to FIG. 4, which shows a circuit block schematic diagram of using a differential ballaster to adjust the current between a plurality of lamps of the prior art. The circuit in FIG. 4 includes a plurality of transformers 12 having a first coil 121 and a second coil 122. One end of the first coils 121 is connected with a reference voltage G and another end is connected with a first lamp 141. Another end of the first lamp 141 is connected with an AC power 10. One end of the second coils 122 is also connected with the reference voltage G and another end is connected with a second lamp 142. Another end of the second lamp 142 is connected with the AC power 10. The AC power 10 utilizes the first coil 121 and the second coil 122 of the transformers 12 to form a differential ballaster for individually providing stable current I1 and I2 to the first lamp 141 and the second lamp 142. Therefore, the current flowing through the first lamp 141 and the second lamp 142 is balanced. However, it only works between two lamps and cannot work for other lamps.

Please refer to FIG. 5, which shows a circuit block schematic diagram of using a differential ballaster to adjust the current between lamps of another prior art. As shown in FIG. 5, it uses two lamps as an example. The two lamps 31 and 32 are connected in parallel. A high voltage end of the two lamps 31 and 32 is connected with an AC power 10 via a differential ballaster 39. The differential ballaster 39 produces an amended voltage. The amended voltage is proportional to the unbalance between the current of the lamps I31 and I32 and adds together to form a common driving voltage. Therefore, the amended driving voltage adjusts the current of the lamps I31 and I32 to balance the current. Although the circuit can ensure that the current of two lamps balances, the circuit includes magnetic cores with specified shape and coil frames. The magnetic cores and the coil frames are not standard products, so it is inconvenient to prepare the raw materials and control the cost of the product.

Please refer to FIG. 6, which shows a circuit block schematic diagram of using a differential ballaster to adjust the current between a plurality of lamps of another prior art. As shown in FIG. 6, a plurality of differential ballasters T1, T2, T3, T4, T5, T6 and T7 are connected with AC power 10 using a tree type. It utilizes a dividing-layer and dividing current principle to divide the current into a plurality of lamps L1, L2, L3, L4, L5, L6, L7 and L8 and balances the current between the lamps. The operating principle is the same as is used in FIG. 5.

There is a common shortage on the circuits for adjusting the current of lamps of the prior art. When the circuit is applied to a plurality of lamps, it only works for two lamps and cannot be applied to lamps with an odd quantity. For the prior art, as shown in FIG. 6, the inductance on the coils are different and it only can be applied to the lamps having an even quantity with 2's order.

### SUMMARY OF THE INVENTION

One particular aspect of the present invention is to provide a current-balancing circuit for lamps. The current-balancing circuit uses a plurality of transformers having a primary winding and a secondary winding. One end of the secondary winding of the transformer is connected with a lamp and another end of the secondary winding of the transformer is connected with an AC power via the primary winding of a neighboring transformer. By the above linking method, the power is provided and balances the working current for the lamps via the transformers.

One embodiment of the current-balancing circuit for lamps connects a first transformer having a first primary winding and a first secondary winding with a second transformer having a second primary winding and a second secondary winding. One end of the second primary winding is connected with a power and another end of the second primary winding is connected with a first lamp via the first secondary winding. One end of the second secondary winding is connected with a second lamp and another end of the second secondary winding is connected with the power via the first primary winding. Thereby, the power provides the same working current for the lamps.

Another embodiment of the current-balancing circuit for lamps connects a first transformer having a first primary winding and a first secondary winding with a second transformer having a second primary winding and a second secondary winding. One end of the second primary winding is connected with a power and another end of the second primary winding is connected with a first lamp via the first secondary winding. The current-balancing circuit for lamps also includes a third transformer having a third primary winding and a third secondary winding. One end of the third primary winding is connected with the power and another end of the third primary winding is connected with a second lamp via the second secondary winding. One end of the third secondary winding is connected with a third lamp and another end of the third secondary winding is connected with the power via the first primary secondary winding. Thereby, the power provides the same working current for the lamps.

The present invention utilizes the characteristics of electrical-magnetic reaction of a transformer and the loops composed of the windings of the transformers and connect them with each other in series to make the current flowing through the windings of the transformers equal. Thereby, the present invention provides the same working current for each lamp that is connected with the winding. At the same times, the present invention can also be applied to lamps with an even or an odd quantity to balance the working current and improve drawbacks of the prior circuit, including when the inductance on the coils are different and when it cannot be applied to lamps with an odd quantity and only can be applied to the lamps having an even quantity with 2's order, as shown in FIG. 6.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of a circuit using a differential ballaster to adjust the current of two lamps of the prior art;

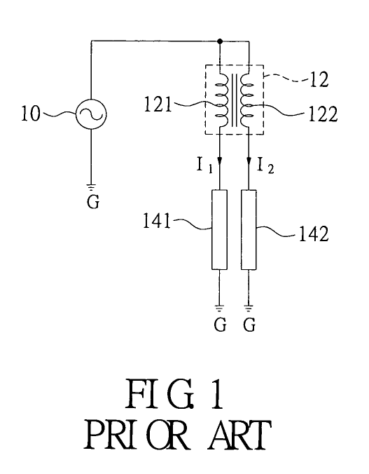

FIG. 2 is a schematic diagram of an equivalent magnetic loop of the transformer in FIG. 1;

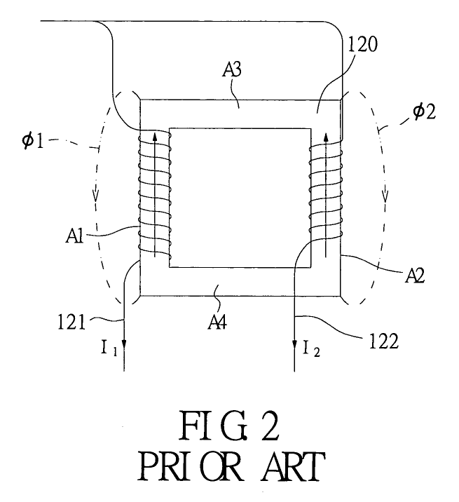

FIG. 3 is a schematic diagram of an equivalent magnetic loop of FIG. 1 connected with lamps;

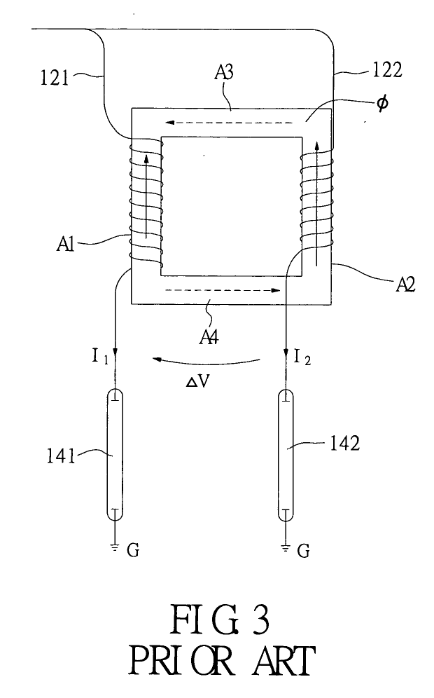

FIG. 4 is a circuit block schematic diagram a differential ballaster being used to adjust the current between a plurality of lamps of the prior art;

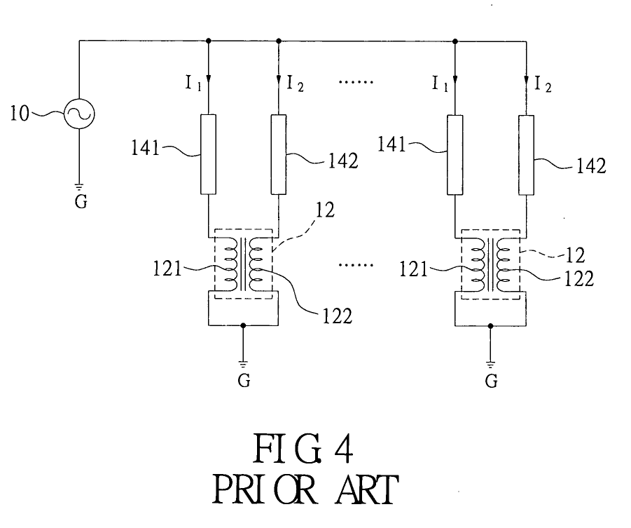

FIG. 5 is a circuit block schematic diagram of a differential ballaster being used to adjust the current between lamps of another prior art;

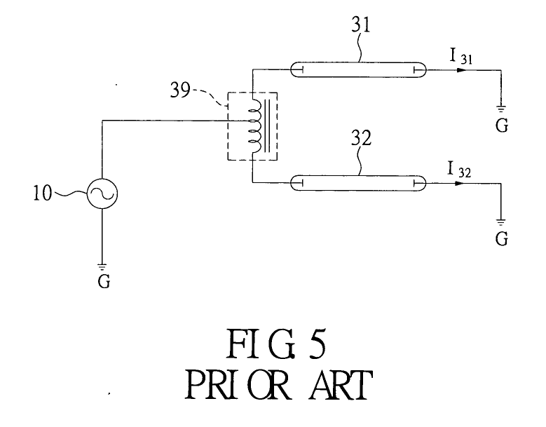

FIG. 6 is a circuit block schematic diagram of a differential ballaster being used to adjust the current between a plurality of lamps of the another prior art;

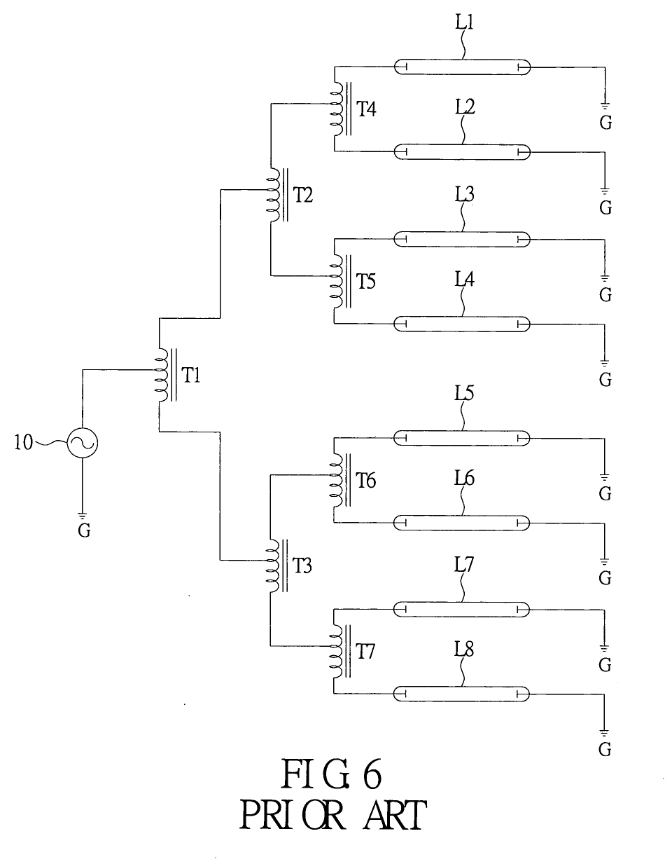

FIG. 7 is a schematic diagram of a current-balancing circuit for two lamps of the first embodiment of the present invention;

FIG. 8 is a schematic diagram of a current-balancing circuit for three lamps of the second embodiment of the present invention;

FIG. 9 is a schematic diagram of a current-balancing circuit for two lamps of the third embodiment of the present invention; and

FIG. 10 is a schematic diagram of a current-balancing circuit for three lamps of the fourth embodiment of the present invention.

### DETAILED DESCRIPTION OF THE PREFERRED EMBODIMENTS

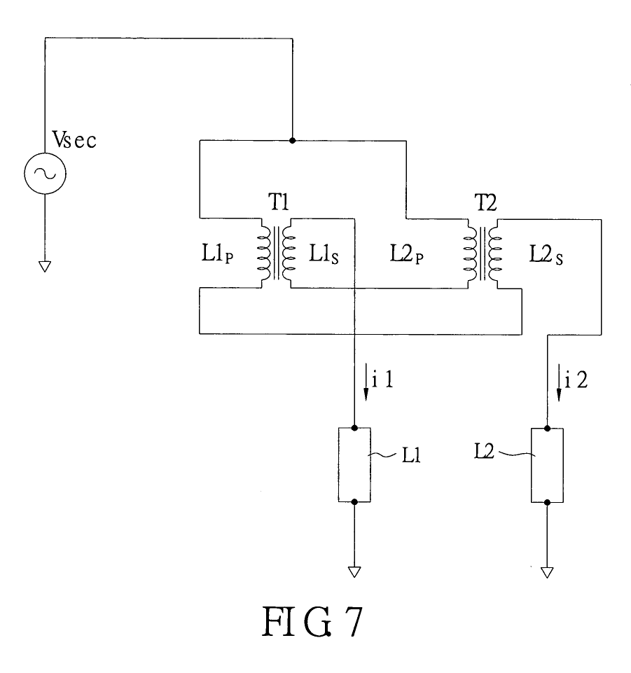

Please refer to FIG. 7, which shows a schematic diagram of a current-balancing circuit for two lamps of the first embodiment of the present invention. The circuit, as shown in FIG. 7, uses two lamps as an example. The current-balancing circuit includes a first transformer T1 having a first primary winding L1p and a first secondary winding L1s, a second transformer T2 having a second primary winding L2p and a second secondary winding L2s. One end of the second primary winding L2p is connected with a power Vsec and another end of the second primary winding L2p is connected with a first lamp L1 via the first secondary winding L1s. One end of the second secondary winding L2s is connected with a second lamp L2 and another end of the second secondary winding L2s is connected with the power Vsec via the first primary winding L1p. Thereby, the power Vsec provides the same working current i1 and i2 for the lamps L1 and L2.

The present invention connects the first secondary winding L1s of the first transformer T1 with the second primary winding L2p of the second transformer T2 in series and connects the first primary winding L1p of the first transformer T1 with the second secondary winding L2s of the second transformer T2 in series. Furthermore, the present invention utilizes the characteristics of electrical-magnetic reaction of the first transformer T1 and the second transformer T2. Thereby, the power Vsec provides current to the first lamp L1 and the second lamp L2 via the windings that are connected with each other in series. By using the formulas (1), the current flowing through the first lamp L1 and the second lamp L2 are obtained and made the same.

Because the first transformer T1 is equivalent to the second transformer

$$T 2 , \\ Ls 1 = Ls 2 , \\ Lp 1 = Lp 2 , \\ Lm = K \cdot \sqrt{Ls 1 \cdot Lp 1}$$

$$\begin{matrix}V sec = ( 2 \cdot π \cdot f \cdot Ls 1 ) \cdot i 1 + ( 2 \cdot π \cdot f \cdot Lp 2 ) \cdot i 1 - 2 \cdot ( 2 \cdot π \cdot f \cdot Lm ) \cdot \\ i 2 + i 1 \cdot RL 2 \\ = ( 2 \cdot π \cdot f \cdot Ls 2 ) \cdot i 2 + ( 2 \cdot π \cdot f \cdot Lp 1 ) \cdot i 2 - 2 \cdot ( 2 \cdot π \cdot f \cdot Lm ) \cdot \\ i 1 + i 2 \cdot RL 1\end{matrix}$$

$$\frac{i 1}{i 2} = \frac{2 \cdot π \cdot f \cdot ( Ls 2 + Lp 1 + 2 \cdot Lm ) + RL 1}{2 \cdot π \cdot f \cdot ( Ls 1 + Lp 2 + 2 \cdot Lm ) + RL 2}$$

If f or (Ls1+Lp1+Lm) is greater than RL1 and RL2, i1=i2.

In the formulas (1), Lp1, Lp2, Ls1 and Ls2 are the inductances of the windings of the first transformer T1 and the second transformer T2; Lm is the reaction inductance; RL1 and RL2 are the resistance of the lamps; Vsec is power; f is the working frequency of the power; k is couple coefficient; and i1 and i2 are current.

The turns of the windings located at two sides of the first transformer T1 and the second transformer T2 are the same so as to form a balancing transformer. Furthermore, the first primary winding is connected with the second secondary winding in series by a polar-adding method and the second primary winding is connected with the first secondary winding in series by a polar-adding method. The first lamp L1 and the second lamp L2 are CCFLs or EEFLs.

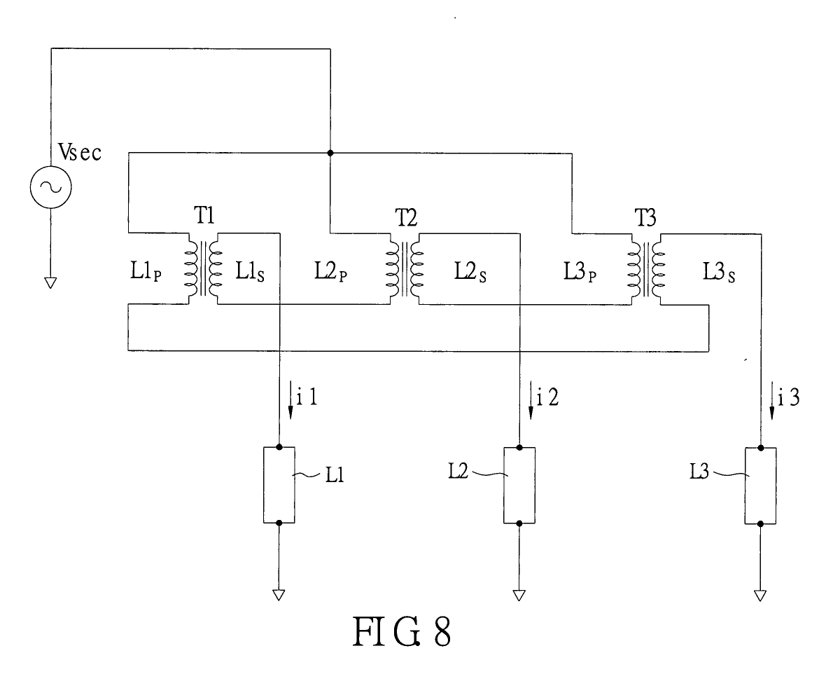

Please refer to FIG. 8, which shows a schematic diagram of a current-balancing circuit for three lamps of the second embodiment of the present invention. The circuit, as shown in FIG. 8, uses three lamps as an example. The current-balancing circuit includes a first transformer T1 having a first primary winding L1p and a first secondary winding L1s, a second transformer T2 having a second primary winding L2p and a second secondary winding L2s and a third transformer T3 having a third primary winding L3p and a third secondary winding L3s. One end of the second primary winding L2p is connected with a power Vsec and another end of the second primary winding L2p is connected with a first lamp L1 via the first secondary winding L1s. One end of the third primary winding L3p is connected with the power Vsec and another end of the third primary winding L3p is connected with a second lamp L2 via the second secondary winding L2s. One end of the third secondary winding L3s is connected with a third lamp L3 and another end of the third secondary winding L3s is connected with the power Vsec via the first primary secondary winding L1p. Thereby, the power Vsec provides the same working current i1, i2 and i3 for the lamps L1, L2 and L3.

The operation principle and formulas of the circuit of the FIG. 8 are the same as the ones of the circuit of the FIG. 7. The present invention can be applied to lamps with an even quantity or an odd quantity to balance the working current and improve drawbacks of the prior circuit, including when the inductance on the coils are different and when it cannot be applied to lamps with an odd quantity and can only be applied to the lamps with an even quantity.

The first lamp L1, the second lamp L2 and the third lamp L3 are CCFLs or EEFLs. The first transformer T1, the second transformer T2 and the third transformer T3 have the same number of turns of the windings. Furthermore, the first primary winding L1p is connected with the third secondary winding L3s in series by a polar-adding method; the second primary winding L2p is connected with the first secondary winding L1s in series by a polar-adding method; and the third primary winding L3p is connected with the second secondary winding L2s in series by a polar-adding method.

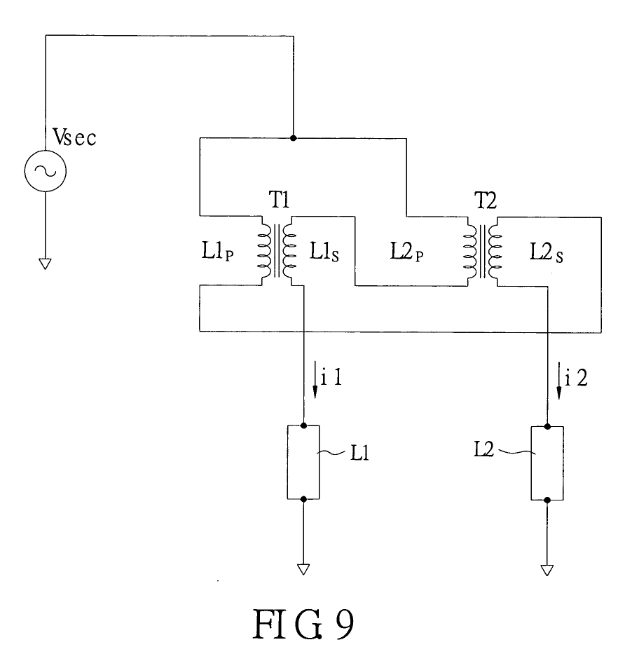

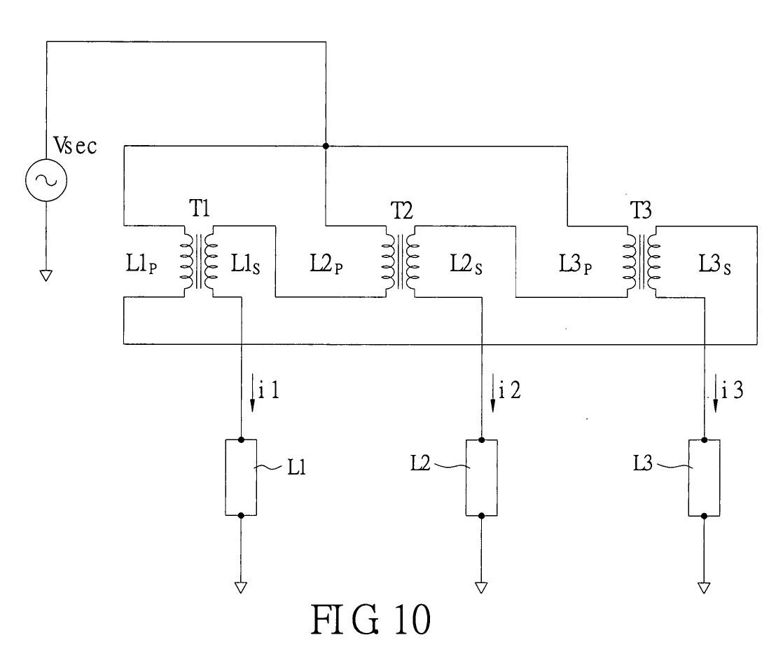

Please refer to FIGS. 7 and 9. FIG. 9 shows a schematic diagram of a current-balancing circuit for two lamps of the third embodiment of the present invention. The connecting method for the windings of the transformers in FIG. 9 is different from that in FIG. 7 due to the fact that the polarity of the windings used in FIG. 7 and FIG. 8 is different. When the windings of the transformers are connected in series, the connecting method has to be based on the polar-adding principle. Please refer to FIGS. 9 and 10. FIG. 10 shows a schematic diagram of a current-balancing circuit for three lamps of the fourth embodiment of the present invention. The operation principle and formulas of the circuit of the FIG. 10 are the same as the ones of the circuit of the FIG. 9. The present invention can be applied to lamps with an even quantity or an odd quantity to balance the working current and improve upon the drawbacks of the prior circuit, including when the inductance on the coils is different and when it cannot be applied to lamps with an odd quantity and can only be applied to lamps with an even quantity.

The present invention provides a current-balancing circuit for lamps. The current-balancing circuit of the present invention adopts a plurality of transformers having a primary winding and a secondary winding. One end of the secondary winding of the transformer is connected with a lamp and another end of the secondary winding of the transformer is connected with an AC power via the primary winding of a neighboring transformer. By the above linking method, the power provides and balances the working current for the lamps via the transformers, and improves upon the drawbacks, including when the inductance on the coils are different and when it cannot be applied to lamps with an odd quantity and it only can be applied to the lamps with an even quantity.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A current-balancing circuit for lamps, comprising:
a plurality of transformers, having a primary winding and a secondary winding, wherein one end of the secondary windings is connected with a lamp and another end of the secondary windings is connected with a power via a primary winding of a neighboring transformer;
thereby, the power provides the same working current for the lamps via the transformers.

2. The current-balancing circuit for lamps as claimed in claim 1, wherein the quantity of the transformers is even or odd.

3. The current-balancing circuit for lamps as claimed in claim 1, wherein the winding of the transformers have the same number of turns.

4. The current-balancing circuit for lamps as claimed in claim 1, wherein the lamps are CCFLs or EEFLs.

5. The current-balancing circuit for lamps as claimed in claim 1, wherein the primary windings and the secondary windings are connected in series by a polar-adding method.

6. A current-balancing circuit for lamps, comprising:
a first transformer, having a first primary winding and a first secondary winding; and
a second transformer, having a second primary winding and a second secondary winding, wherein one end of the second primary winding is connected with a power and another end of the second primary winding is connected with a first lamp via the first secondary winding, and one end of the second secondary winding is connected with a second lamp and another end of the second secondary winding is connected with the power via the first primary winding;
thereby, the power provides the same working current for the lamps.

7. The current-balancing circuit for lamps as claimed in claim 6, wherein the first lamp and the second lamp are CCFLs or EEFLs.

8. The current-balancing circuit for lamps as claimed in claim 6, wherein the winding of the first transformer and the second transformer have the same number of turns.

9. The current-balancing circuit for lamps as claimed in claim 6, wherein the first primary windings and the second secondary windings are connected in series by a polar-adding method.

10. The current-balancing circuit for lamps as claimed in claim 6, wherein the second primary windings and the first secondary windings are connected in series by a polar-adding method.

11. A current-balancing circuit for lamps, comprising:
a first transformer, having a first primary winding and a first secondary winding;
a second transformer, having a second primary winding and a second secondary winding, wherein one end of the second primary winding is connected with a power and another end of the second primary winding is connected with a first lamp via the first secondary winding; and
a third transformer, having a third primary winding and a third secondary winding, wherein one end of the third primary winding is connected with the power and another end of the third primary winding is connected with a second lamp via the second secondary winding, and one end of the third secondary winding is connected with a third lamp and another end of the third secondary winding is connected with the power via the first primary winding;
thereby, the power provides the same working current for the lamps.

12. The current-balancing circuit for lamps as claimed in claim 11, wherein the first lamp, the second lamp and the third lamp are CCFLs or EEFLs.

13. The current-balancing circuit for lamps as claimed in claim 11, wherein the winding of the first transformer, the second transformer and the third transformer have the same number of turns.

14. The current-balancing circuit for lamps as claimed in claim 11, wherein the first primary windings and the third secondary windings are connected in series by a polar-adding method.

15. The current-balancing circuit for lamps as claimed in claim 11, wherein the second primary windings and the first secondary windings are connected in series by a polar-adding method.

16. The current-balancing circuit for lamps as claimed in claim 11, wherein the third primary windings and the second secondary windings are connected in series by a polar-adding method.
